(19) United States
(12) Patent Application Publication
(10) Pub. No.: US 2010/0036508 A1
(43) Pub. Date: Feb. 11, 2010

(54) ENABLING NON-INTEROPERABILITY AMONG TRANSCEIVERS OF DEVICES

(75) Inventors: Sthanunathan RAMAKRISHNAN, Bangalore (IN); Divyesh Kumar Shah, Bangalore (IN)

Correspondence Address: TEXAS INSTRUMENTS INCORPORATED, P O BOX 655474, M/S 3999, DALLAS, TX, 75265, US

(73) Assignee: Texas Instruments Incorporation, Dallas, TX (US)

(21) Appl. No.: 12/536,617

(22) Filed: Aug. 6, 2009

Related U.S. Application Data
(60) Provisional application No. 61/086,663, filed on Aug. 6, 2008.
(60) Provisional application No. 61/088,237, filed on Aug. 12, 2008.

(51) Int. Cl. G05B 9/02; H04B 1/38

(52) U.S. Cl. 700/21; 375/219

(57) ABSTRACT

Enabling non-interoperability among transceivers of devices. A method includes transmitting a signal at a predefined symbol rate by a first transceiver of a first device of a first plurality of devices. The predefined symbol rate is unique for each transceiver of each device of the first plurality of devices. The method also includes detecting the signal by a second transceiver of a second device of a second plurality of devices. The second transceiver has a symbol rate similar to the predefined symbol rate.

### REFERENCE TO PRIORITY APPLICATION

This application claims priority from U.S. Provisional Application Ser. No. 61/086,663 filed Aug. 6, 2008, entitled “Wake-up signaling in MICS implants”, U.S. Provisional Application Ser. No. 61/088,237 filed Aug. 12, 2008, entitled “Wake-up signaling in MICS implants”, U.S. Non-provisional application Ser. No. 12/536,520 filed Aug. 6, 2009, entitled “Signaling in a medical implant based system”, and U.S. Non-provisional application Ser. No. 12/536,592 filed Aug. 6, 2009, entitled “Power optimization in a medical implant based system” which in turn claims priority from U.S. Provisional Application Ser. No. 61/086,663 filed Aug. 6, 2008, entitled “Wake-up signaling in MICS implants” and U.S. Provisional Application Ser. No. 61/088,074 filed Aug. 12, 2008, entitled “Packet structure and transmission strategy for optimizing power consumption in medical implants”, which are incorporated herein by reference in their entirety.

### TECHNICAL FIELD

Embodiments of the disclosure relate to enabling non-interoperability among transceivers of devices.

### BACKGROUND

A medical implant based system includes one or more devices, for example medical controllers and medical implants. The medical controllers and the medical implants can be associated with different vendors. Each medical implant is present in body of a living organism and each medical controller is external. Inter-operation between similar transceivers used in the devices of different vendors can result in malfunctioning and can also endanger life of the living organism. Further, the inter-operation between similar transceivers used in the devices monitoring different organs of the living organism can result in malfunctioning and can also endanger life of the living organism. Hence, the inter-operation needs to be prevented.

Currently, the inter-operation can be avoided by assigning unique bits to each vendor at a medium access control (MAC) layer. However, a medical implant of a vendor needs to process a signal at the MAC layer to determine whether the signal is transmitted by a medical controller of the vendor. Processing till the MAC layer consumes power. The power consumption in the transceiver of the medical implant forms a significant portion of overall power consumption in the medical implant. It is desired to optimize power consumption in the transceiver of the medical implant to increase lifetime of the medical implant.

### SUMMARY

An example of a method for enabling non-interoperability among transceivers of devices includes transmitting a signal at a predefined symbol rate by a first transceiver of a first device of a first plurality of devices. The predefined symbol rate is unique for each transceiver of each device of the first plurality of devices. The method also includes detecting the signal by a second transceiver of a second device of a second plurality of devices. The second transceiver has a symbol rate similar to the predefined symbol rate.

Another example of a method for enabling non-interoperability among transceivers of devices includes encoding a signal with a predefined pattern, at a physical layer, by a first transceiver of a first device of a first plurality of devices. The predefined pattern is unique for each transceiver of each device of the first plurality of devices. The method also includes transmitting the signal. The method further includes processing the signal by a second transceiver of a second device of a second plurality of devices. The second transceiver has a pattern similar to the predefined pattern.

An example of a system enabling non-interoperability among transceivers of devices includes a first medical controller including a first transceiver that transmits a first signal. The first signal is associated with a first predefined parameter. The system also includes a second medical controller including a second transceiver configured to transmit a second signal associated with a second predefined parameter. Further, the system includes a medical implant including a third transceiver configured to process a signal associated with the first predefined parameter that processes the first signal and discards the second signal.

### BRIEF DESCRIPTION OF THE VIEWS OF DRAWINGS

In the accompanying figures, similar reference numerals may refer to identical or functionally similar elements. These reference numerals are used in the detailed description to illustrate various embodiments and to explain various aspects and advantages of the disclosure.

FIG. 1 illustrates an environment, in accordance with one embodiment;

FIG. 2 illustrates an exemplary structure of a signal, in accordance with one embodiment;

FIG. 3 is a flow diagram illustrating a method for enabling non-interoperability among transceivers of devices, in accordance with one embodiment;

FIG. 4 is a flow diagram illustrating a method for enabling non-interoperability among transceivers of devices, in accordance with another embodiment;

FIG. 5 illustrates a block diagram of a portion of a medical controller transceiver, in accordance with one embodiment; and

FIG. 6 illustrates a block diagram of a portion of a medical implant transceiver, in accordance with one embodiment.

### DETAILED DESCRIPTION OF THE EMBODIMENTS

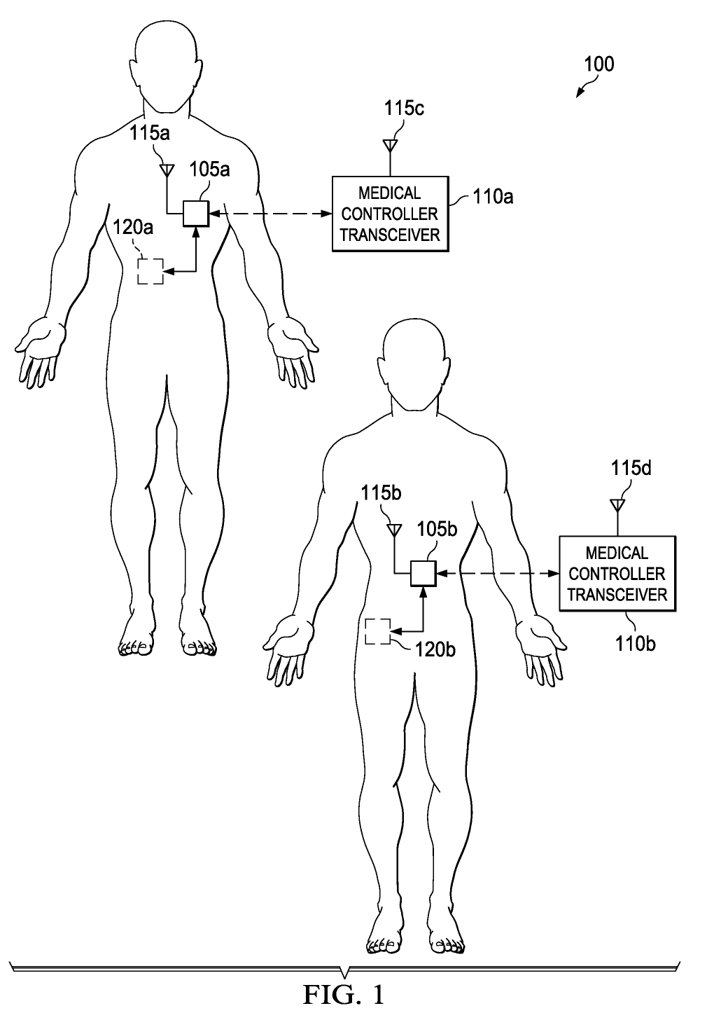

FIG. 1 illustrates an environment 100 including a medical implant based system. Examples of the environment 100 include, but are not limited to, intensive care units (ICUs), hospital wards, and home environment. The environment 100 includes one or more medical implant transceivers (hereinafter referred to as the implant transceivers) for example a medical implant transceiver 105a (hereinafter referred to as the implant transceiver 105a) and a medical implant transceiver 105b (hereinafter referred to as the implant transceiver 105b), and one or more medical controller transceivers (hereinafter referred to as the controller transceivers), for example a medical controller transceiver 110a (hereinafter referred to as the controller transceiver 110a) and a medical controller transceiver 110b (hereinafter referred to as the controller transceiver 110b). The implant transceivers (105a and 105b) are present inside living organisms to monitor health and to transmit health details to the controller transceivers (110a and 110b). The implant transceivers (105a and 105b) are included in different medical implants. The controller transceivers (110a and 110b) are included in different medical controllers.

The implant transceiver 105a includes or is connected to an antenna 115a, and the implant transceiver 105b includes or is connected to an antenna 115b to transmit and receive signals. The implant transceiver 105a can also include or be connected to sensors, for example a sensor 120a and the implant transceiver 105b can also include or be connected to sensors, for example a sensor 120b. Each sensor monitors and senses various health details. Examples of the sensors include, but are not limited to, pacemakers and brain sensors. Similarly, the controller transceiver 110a includes or is connected to an antenna 115c, and the controller transceiver 110b includes or is connected to an antenna 115d to transmit and receive signals.

An implant transceiver, for example the implant transceiver 105a, and a controller transceiver, for example the controller transceiver 110a, can communicate with each other in an Implant Communication Service (MICS) frequency band. The MICS frequency band ranges from 402 megahertz (MHz) to 405 MHz. The implant transceiver 105a and the controller transceiver 110a can also communicate with each other in a Medical Data Services (MEDS) frequency band. The MEDS frequency band ranges from 401 MHz to 402 MHz, and from 405 MHz to 406 MHz. The frequency band can be referred to as a band of channels.

A communication session is initiated by the controller transceiver 110a. The controller transceiver 110a selects a channel for transmission based on certain parameters. In one example, the controller transceiver 110a selects either a least interfered channel or a channel which has interference power below a threshold. The selection process can be referred to as “Listen Before Talk” (LBT). The controller transceiver 110a then transmits a signal in the channel. The signal can be of various types, for example a signal for association, a poll signal and a signal for data transfer.

In one example, the controller transceiver 110a and the implant transceiver 105a are of a first vendor, and the controller transceiver 110a and the implant transceiver 105a are of a second vendor. The first vendor is different from the second vendor. In another example, the controller transceiver 110a and the implant transceiver 105a are associated with a first organ of the living organism, and the controller transceiver 110a and the implant transceiver 105a are associated with a second organ of the living organism. The first organ is different from the second organ. Examples of the organ include, but are not limited to, heart, kidney and brain.

A unique predefined pattern or a unique symbol rate or both are assigned to transceivers to be included in devices that are to be used for different vendors or different organs. For example, the controller transceiver 110a and the implant transceiver 105a are assigned a first predefined pattern or a first symbol rate or both, and the controller transceiver 110b and the implant transceiver 105b are assigned a second predefined pattern or a second symbol rate or both. The first predefined pattern is different from the second predefined pattern, and the first symbol rate is different from the second symbol rate.

The controller transceivers (110a and 110b) transmit signals for respective implant transceivers (105a and 105b), and it is desired that the implant transceiver 105a detects and respond to a signal transmitted by the controller transceiver 110a and not from the controller transceiver 110b. The controller transceiver 110a can be referred to as a first transceiver and the controller transceiver 110a can be referred to as a second transceiver. The implant transceiver 105a can be referred to as a third transceiver that detects the signal from the controller transceiver 110a and discards the signal from the controller transceiver 110b.

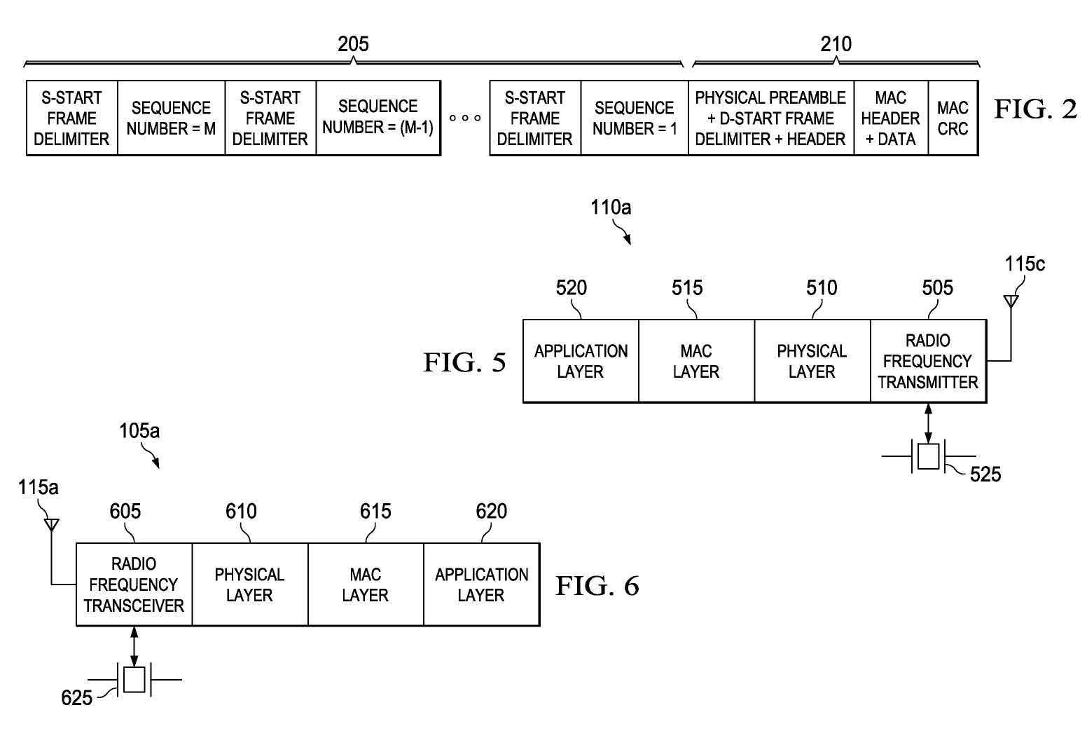

An exemplary structure of a signal transmitted by a controller transceiver, for example the controller transceiver 110a, for enabling the implant transceiver 105a to detect the signal and the implant transceiver 105b to discard the signal is explained in detail in conjunction with FIG. 2.

FIG. 2 illustrates an exemplary structure of a signal. The signal includes various portions or packets. The portions can include a portion 205 and a subsequent portion 210. The signal can have other portions too. Each portion can be processed at a different layer. Examples of layers, in order from lower layer to higher layer, include a physical layer, a medium access control (MAC) layer and other higher layers. A controller transceiver encodes the signal by processing portions at various layers. The controller transceiver, functioning as a transmitter, starts encoding the portions at a highest layer and adds data corresponding to each layer as the portions move from the highest layer towards the physical layer. At an implant transceiver, functioning as a receiver, the portions move from the physical layer towards the higher layers. The implant transceiver starts decoding the portions at the physical layer and removes data corresponding to each layer as the portions move from the physical layer towards the higher layers.

The portion 205 can include sequence numbers and multiple instances of a start frame delimiter (SFD), for example a first SFD, hereinafter referred to as S-SFD. The S-SFD indicates start of the portion 205. The S-SFD can be an 18 bit value or 2 bytes value. A particular bit pattern can be set as the S-SFD. The S-SFD is followed by a sequence number field which is indicative of a time duration after which the subsequent portion 210 of the signal will start. The sequence numbers proceed in a sequential order, for example a decrementing order M to 1 and an incrementing order. The sequence number can be a 16 bit or a 14 bit value. Each sequence number is preceded by the S-SFD. None of the sequence numbers match the S-SFD. For example, if the S-SFD is a set pattern of [zeros (1,15) 1 1 1] the sequence number can decrement till 0 and still remain different from the S-SFD.

The portion 205 can act as a preamble to the subsequent portion 210. The portion 205 and the subsequent portion 210 can together be referred to as a beacon.

The subsequent portion 210 can be referred to as a physical layer portion. The subsequent portion 210 can include a preamble, a data SFD (D-SFD) and a header field for a physical layer, a medium access control (MAC) header, data field, and a MAC cyclic redundancy check (CRC) field.

In one aspect, the D-SFD is unique for each vendor and can be referred to as a predefined pattern. The vendor can be a manufactures or a supplier or a distributor of a medical implant or a medical controller. In another aspect, the D-SFD can also be specific for a particular type of controller transceiver or implant transceiver, for example the D-SFD can be unique for each organ of a living organism. A controller transceiver and an implant transceiver for kidney, and a controller transceiver and an implant transceiver for heart can have different D-SFD.

The header field for the physical layer can include information associated with the controller transceiver and the implant transceiver. The MAC header includes MAC identifications which can be used to verify whether the signal is intended for the implant transceiver or not. The data field includes information regarding data transmission. A MAC Cyclic Redundancy Check (CRC) field performs CRC computations using MAC header bits. The CRC computations provide protection against unexpected errors.

In some embodiments, the S-SFD can be referred to as the predefined pattern and the S-SFD can be unique for each vendor or each organ.

In one embodiment, the signal structure can also include the S-SFD, followed by a sequence number, followed by the subsequent portion 210 or a part of the subsequent portion 210, followed by the S-SFD, followed by a subsequent sequence number and so on.

In another embodiment, the signal structure may not include the S-SFD or D-SFD. The signal can be encoded using a predefined sequence, for example a pseudorandom sequence, a gold code sequence, a barker sequence or a walsh code sequence. A unique predefined sequence can be used for each vendor or each organ and can be referred to as the predefined pattern.

The S-SFD or the D-SFD can be selected based on various criteria. Any two S-SFD or two D-SFD differ from each other by at least five bits. Further, no two S-SFD or two D-SFD are a 180 degrees phase shift of each other. No S-SFD and D-SFD are a 180 degrees phase shift of each other or any sequence number. Further, no portion of any S-SFD or D-SFD in combination with any sequence number results in the predefined pattern. Similarly, no portion of the preamble in combination with portion of the S-SFD or D-SFD results in the predefined pattern. The number of bit patterns satisfying the criteria can vary based on length of the bit pattern. For example, for a length of 16 bits fifteen patterns of D-SFD satisfying the criteria can be determined. The 15 different patterns of the D-SFD can be used to identify 15 different vendors.

It is noted that the criteria are exemplary and the S-SFD or D-SFD satisfying at least one criterion from the criteria can be selected based on requirement.

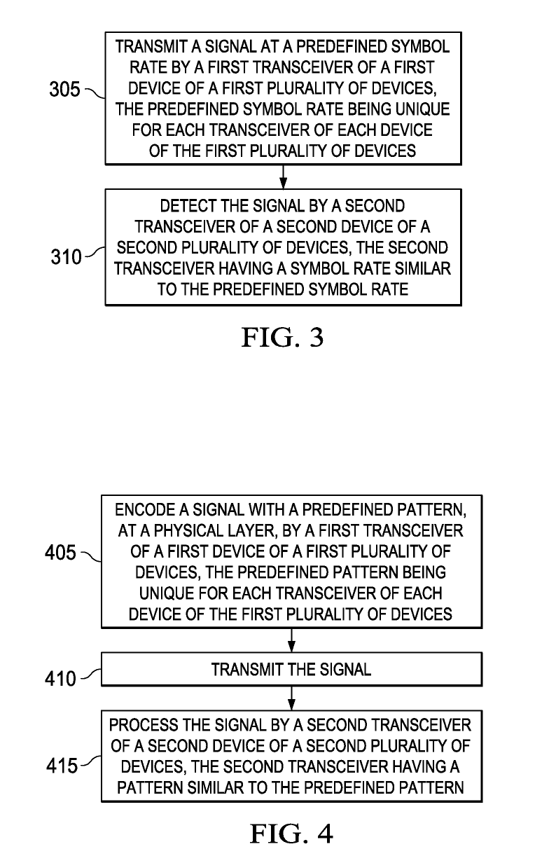

FIG. 3 is a flow diagram illustrating a method for enabling non-interoperability among transceivers of devices. At step 305, a signal is transmitted at a predefined symbol rate by a first transceiver of a first device of a first plurality of devices. The predefined symbol rate is unique for each transceiver of each device of the first plurality of devices. The first device corresponds to a first vendor or to a first organ of a living organism or to both. Different vendors or different organs are assigned different symbol rates. The first transceiver sends and receives signals at the symbol rate assigned to the first vendor or the first organ. The symbol rates can be assigned based on certain criteria. For example, the symbol rate can be selected such that the difference in any two symbol rates is at least 10000 parts per million (ppm). If a nominal symbol rate is 200 KHz, then the symbol rate for other vendors can be 198 KHz (200 KHz*(1−ê2)), 196 KHz, 194 KHz and so on.

In one embodiment, the first plurality of devices includes medical controllers. In another embodiment, the first plurality of devices includes medical implants.

At step 310, the signal is detected by a second transceiver of a second device of a second plurality of devices. The second transceiver has a symbol rate similar to the predefined symbol rate to transmit and receive signals. The second transceiver corresponds to the first vendor or to the first organ or to both.

In one embodiment, the second plurality of devices includes medical implants. In another embodiment, the first plurality of devices includes medical controllers.

In one embodiment, transceivers of other devices of the second plurality of devices cannot detect the signal as they are configured to operate at a symbol rate different than that of the transceiver of the second device. In another embodiment, the transceivers may detect the signal and determine that a frequency offset exceeds a threshold. If the frequency offset exceeds the threshold then the symbol rate of the signal can be determined to be different than that of the transceiver of the second device and hence the signal can be considered as undetected. The transceivers then enter into an inactive state to save power.

In one embodiment, the different symbol rates can be obtained by using different crystal oscillators for different vendors or organs. In another embodiment, the different symbol rates can be achieved by using a similar crystal oscillator but different frequency dividers for each vendor or organ. For example, two vendors can choose frequencies of 25.6 megahertz (MHz) and 26 MHz. The frequency offset can then be 15000 (0.4 MHz/26 MHz) ppm. The frequency offset of the transceiver can be set to a maximum of 500 ppm to enable the transceiver to reject signals having frequency offset higher than 500 ppm.

Referring now to FIG. 4, at step 405, a signal is encoded with a predefined pattern by a first transceiver of a first device of a first plurality of devices. The encoding can be performed at a physical layer. The predefined pattern is unique for each transceiver of each device of the first plurality of devices. The first device corresponds to a first vendor or to a first organ of a living organism or to both. Different vendors or different organs are assigned different predefined patterns. The predefined patterns are selected based on certain criteria and embedded in the transceiver.

In one embodiment, the first plurality of devices includes medical controllers. In another embodiment, the first plurality of devices includes medical implants.

The signal is transmitted, at step 410, by the first transceiver. The signal can be transmitted at a predefined symbol rate. The symbol rate can be same or different for the devices corresponding to different vendors or organs.

At step 415, the signal is received and processed by a second transceiver of a second device of a second plurality of devices. In some embodiments, the second device corresponds to the similar vendor or the similar organ of the living organism as the first device and has a pattern or knowledge of the pattern similar to the predefined pattern. The second device can also have the symbol rate similar to that of the first device. The second transceiver detects the signal as the pattern matches the predefined pattern.

In one embodiment, transceivers of other devices in the second plurality of devices do not detect the signal as the predefined pattern does not match with patterns of the other devices. The other devices may be of different vendors or may be used for different organs. In another embodiment, each device may have the patterns of other vendors or organs embedded. If a transceiver detects that the predefined pattern matches pattern of any other vendor or organ then also the transceiver can discard the signal and enter into an inactive state to save power.

In one embodiment, the second plurality of devices includes medical implants. In another embodiment, the first plurality of devices includes medical controllers.

FIG. 5 illustrates a block diagram of a portion of a controller transceiver, for example a controller transceiver 110a. The controller transceiver 110a includes a radio frequency transmitter 505 that sends signals, for example a portion of a signal. The signal can be associated with a predefined parameter, for example a symbol rate or a predefined pattern. The controller transceiver 110a includes several layers, for example a physical layer 510, a MAC layer 515, and an application layer 520 for processing the signal. An antenna 115c is connected to the radio frequency transmitter 505 to transmit signals.

The controller transceiver 110a can also include a radio frequency receiver that receives signals. In one embodiment, a radio frequency transceiver can be present for performing functions of the radio frequency transmitter 505 and the radio frequency receiver.

Each layer includes a circuit for performing specified functions. The circuit can operate in response to instructions stored in a memory or a machine-readable medium. Examples of the machine-readable medium include, but are not limited to, magnetic disks, optical disks and other electrical or magnetic storage medium.

In one embodiment, a circuit of the physical layer 510 encodes the portion of the signal with the predefined pattern unique to the controller transceiver 110a.

In another embodiment, the controller transceiver 110a can include or be coupled to a crystal oscillator 525. The crystal oscillator 525 can be present on a circuit board included in the controller or can be packaged along with the controller transceiver 110a.

The crystal oscillator 525 is responsive to the signal to provide a predefined frequency to the controller transceiver 110a to transmit the signal at the symbol rate. The predefined frequency is unique for each vendor or each organ. In one example, different crystal oscillators can be used for different vendors or different organs. In another example, the crystal oscillator 525 can be used for different vendors or different organs and a unique frequency divider can be coupled to the crystal oscillator 525 for each vendor or organ. The frequency divider obtains the predefined frequency from the crystal oscillator 525. For example, from a 25.6 MHz crystal oscillator, 200 KHz can be obtained by using a frequency divider having a division factor of 128. By using a frequency divider having a division factor of 132, 194 KHz can be obtained.

It is noted that various known circuits for the physical layer 510 can be used.

FIG. 6 illustrates a block diagram of a portion of an implant transceiver, for example an implant transceiver 105a. The implant transceiver 105a includes a radio frequency transceiver 605 that receives signals, for example a portion of a signal. The signal can be associated with a predefined parameter, for example a symbol rate or a predefined pattern. The implant transceiver 105a includes several layers, for example a physical layer 610, a MAC layer 615, and an application layer 620, for processing the signal. An antenna 115a is connected to the radio frequency transceiver 605 to transmit and receive signals.

Each layer includes a circuit for performing specified functions. For example, a circuit of the physical layer 610 is responsive to the portion of the signal to detect a predefined pattern in the portion of the signal. If the predefined pattern is detected then the signal is processed further, else the signal is discarded.

The implant transceiver 105a can include or be coupled to a crystal oscillator 625. The crystal oscillator 625 is responsive to the signal to provide a predefined frequency to the implant transceiver 105a to detect the signal sent at a predefined symbol rate. The predefined frequency is unique for each vendor or each organ. In one example, different crystal oscillators can be used for different vendors or different organs. In another example, the crystal oscillator 625 can be used for different vendors or different organs and a unique frequency divider can be coupled to the crystal oscillator 625 for each vendor or organ. The frequency divider obtains the predefined frequency from the crystal oscillator 625.

It is noted that various known circuits for the physical layer 610 can be used.

Various embodiments enable non-interoperability among transceivers of devices of different vendors or different organs by using a predefined pattern or a predefined symbol rate or both.

In the foregoing discussion, the term “coupled or connected” refers to either a direct electrical connection between the devices connected or an indirect connection through intermediary devices. The term “signal” means at least one current, voltage, charge, data, or other signal.

The foregoing description sets forth numerous specific details to convey a thorough understanding of embodiments of the disclosure. However, it will be apparent to one skilled in the art that embodiments of the disclosure may be practiced without these specific details. Some well-known features are not described in detail in order to avoid obscuring the disclosure. Other variations and embodiments are possible in light of above teachings, and it is thus intended that the scope of disclosure not be limited by this Detailed Description, but only by the Claims.

What is claimed is:

1. A method for enabling non-interoperability among transceivers of devices, the method comprising:
transmitting a signal at a predefined symbol rate by a first transceiver of a first device of a first plurality of devices, the predefined symbol rate being unique for each transceiver of each device of the first plurality of devices; and
detecting the signal by a second transceiver of a second device of a second plurality of devices, the second transceiver having a symbol rate similar to the predefined symbol rate.

2. The method as claimed in claim 1 and further comprising:
non-detection of the signal by transceivers of other devices of the second plurality of devices, each transceiver from the transceivers of the other devices having a symbol rate different from the predefined symbol rate.

3. The method as claimed in claim 2 and further comprising:
entering into an inactive state by the transceivers of the other devices of the second plurality of devices.

4. The method as claimed in claim 1, wherein the first device and the second device corresponds to at least one of:
a similar vendor; and
a similar organ of a living organism.

5. The method as claimed in claim 4, wherein:
the first plurality of devices comprise medical controllers corresponding to at least one of
different vendors, and
different organs of the living organism; and
the second plurality of devices comprise medical implants corresponding to at least one of
the different vendors, and
the different organs of the living organism.

6. The method as claimed in claim 4, wherein:
the first plurality of devices comprise medical implants corresponding to at least one of
different vendors, and
different organs of the living organism; and
the second plurality of devices comprise medical controllers corresponding to at least one of
the different vendors, and
the different organs of the living organism.

7. A method for enabling non-interoperability among transceivers of devices, the method comprising:
encoding a signal with a predefined pattern, at a physical layer, by a first transceiver of a first device of a first plurality of devices, the predefined pattern being unique for each transceiver of each device of the first plurality of devices;
transmitting the signal; and
processing the signal by a second transceiver of a second device of a second plurality of devices, the second transceiver having a pattern similar to the predefined pattern.

8. The method as claimed in claim 7 and further comprising:
non-detection of the signal by transceivers of other devices of the second plurality of devices, each transceiver from the transceivers of the other devices having a pattern different from the predefined pattern.

9. The method as claimed in claim 8 and further comprising:
entering into an inactive state by the transceivers of the other devices of the second plurality of devices.

10. The method as claimed in claim 7, wherein the first device and the second device corresponds to at least one of:
a similar vendor; and
a similar organ of a living organism.

11. The method as claimed in claim 10, wherein:
the first plurality of devices comprise medical controllers corresponding to at least one of
different vendors, and
different organs of the living organism; and
the second plurality of devices comprise medical implants corresponding to at least one of
the different vendors, and
the different organs of the living organism.

12. The method as claimed in claim 10, wherein:
the first plurality of devices comprise medical implants corresponding to at least one of
different vendors, and
different organs of the living organism; and
the second plurality of devices comprise medical controllers corresponding to at least one of
the different vendors, and
the different organs of the living organism.

13. The method as claimed in claim 1, wherein the predefined pattern comprises:
a bit pattern that differs by at least five bits from any other bit pattern of any other device of a similar type.

14. The method as claimed in claim 1, wherein the predefined pattern comprises:
a pseudorandom sequence that differs from any other pseudorandom sequence of any other device of a similar type.

15. A system for enabling non-interoperability among transceivers of devices, the system comprising:
a first medical controller comprising
a first transceiver that transmits a first signal, the first signal being associated with a first predefined parameter;
a second medical controller comprising
a second transceiver configured to transmit a second signal, the second signal being associated with a second predefined parameter; and
a medical implant comprising
a third transceiver configured to process a signal associated with the first predefined parameter that processes the first signal and discards the second signal.

16. The system as claimed in claim 15, wherein the first medical controller and the medical implant are of a similar vendor, and the second medical controller is of a different vendor.

17. The system as claimed in claim 15, wherein the first medical controller and the medical implant are used for a similar organ of a living organism, and the second medical controller is used for a different organ of the living organism.

18. The system as claimed in claim 15, wherein each predefined parameter is at least one of:
a symbol rate;
a bit pattern; and
a pseudorandom sequence.

19. The system as claimed in claim 15, wherein:
each of the first medical controller and the medical implant comprise a similar crystal oscillator to provide a first predefined frequency to the first transceiver and the third transceiver; and
the second medical controller comprises a different crystal oscillator to provide a second predefined frequency to the second transceiver.

20. The system as claimed in claim 15, wherein:
each of the first medical controller, the medical implant and the second medical controller comprise a similar crystal oscillator,
each of the first medical controller and the medical implant comprise a similar frequency divider to provide a first predefined frequency to the first transceiver and the third transceiver; and
the second medical controller comprises a different frequency divider to provide a second predefined frequency to the second transceiver.
